(19) United States
(12) Patent Application Publication
(10) Pub. No.: US 2011/0045142 A1
(43) Pub. Date: Feb. 24, 2011

(54) Nutritional supplement for promoting weight loss

(76) Inventor: David Alpern, Los Angeles, CA (US)

Correspondence Address: ZUBER & TAILLIEU LLP, 777 SOUTH FIGUEROA ST., 37th FLOOR, LOS ANGELES, CA, 90017, US

(21) Appl. No.: 12/546,643

(22) Filed: Aug. 24, 2009

(51) Int. Cl. A23L 1/302; A23L 1/29

(52) U.S. Cl. 426/72; 426/92; 426/311

(57) ABSTRACT

A nutritional supplement for accelerating weight loss and prevention of dementia and other similar afflictions of the mind includes capsulated concentrations of omega-3 fatty acids and caffeine. Softgel capsules deliver up to 1200 mg of the nutritional supplement to the human body. The omega-3 fatty acids are derived from fish oil and may include both DHA and EPA substances. The combination of omega-3 fatty acids and caffeine accelerate weight loss and help prevent the onset and progress of dementia and dementia-related illnesses. The nutritional supplement is also effective for reducing risks of heart disease and heart attack, and generally aids in promoting cardiovascular health.

### CROSS REFERENCE TO RELATED APPLICATIONS

Not applicable.

### STATEMENT REGARDING FEDERALLY-SPONSORED RESEARCH OR DEVELOPMENT

Not applicable.

### REFERENCE TO SEQUENCE LISTING, A TABLE, OR A COMPUTER PROGRAM LISTING COMPACT DISK APPENDIX

Not applicable.

### BACKGROUND OF THE INVENTION

The present invention relates generally to a nutritional supplement for promoting weight loss. Specifically, the present invention relates to a composition having omega-3 fatty acids and caffeine in a capsule or other form for delivery to the human body.

U.S. Pat. No. 6,838,109 to Nunes et al. describes a composition that includes a fatty acid, which is preferably an omega-3 fatty acid derived from fish oil, a pectin compound, and an alginate compound. The composition may be in the form of a food or beverage composition or other health care composition, such as pill or gel cap. Nunes further provides that the composition may be in the form of a beverage and may include tea solids (such as green tea extract, etc.) The Nunes patent indicates that the composition may be marketed as food or beverage compositions under a variety of regulatory guidelines including dietary supplements, medical foods, pharmaceutical, and/or over the counter compositions.

U.S. Pat. No. 6,743,770 to Bell et al. describes a food composition for minimizing the physiologic effects of stress, which includes a low glycemic-index carbohydrate, fat (preferably an omega-3 fatty acid) and caffeine. Bell provides that the composition can be made in a variety of forms, such as pharmaceutical compositions (tablet, powder, liquid, capsule, gel), a beverage, pudding, ice cream, and other confections, or a nutritional bar. Bell further indicates that long-term administration of the nutritional supplement may aid in the reduction of health risks such as diminished mental and physical performance, dampened immune function, cardiovascular disease, hypertension, obesity and diabetes.

U.S. Pat. No. 6,455,095 to Wong et al. describes a dietary supplement having a legume protein containing galactosidase, methionine, medium-chain fatty acids such as omega-3 fatty acids, and thermogenic additives. Wong describes a dietary supplement for controlling and promoting weight loss which includes the legume protein. The formula further contains well known thermogenic supplements, including caffeine, chromium and ephedra extracts. Wong further states that other ingredients may include naturally occurring omega-3 fatty acids, which stimulate thermogenesis and lower the glycemic index of foods.

U.S. Pat. No. 5,403,826 to Cope et al. describes an enteral nutritional product for persons infected with HIV which may be used as a dietary supplement in order to control wasting. The nutritional product includes protein, carbohydrates, various vitamins and minerals, and fat, preferably derived at least in part from omega-3 fatty acids of fish oils. Cope describes two preferred embodiments, chocolate and orange cream, and indicates that the chocolate version includes the addition of cocoa powder having approximately 8.38 mg of caffeine per 8 fl. oz.

One issue with existing compositions and supplements derived therefrom is the relative oxidative instability of omega-3 fatty acids. This is exacerbated when combined with other substances. Introduction of substances into omega-3 fatty acid compositions may result in a decrease in time to spoilage. Additionally, some substances are not soluble in an omega-3 fatty acid composition, resulting in gritty and/or cloudy compositions which do not have a pleasant taste or appearance.

It is therefore on object of the present invention to provide a commercially viable nutritional supplement which includes omega-3 fatty acids and other substances such as caffeine to promote and accelerate weight loss. It is a further object of the present invention to encapsulate such a nutritional supplement and the substances therein to prevent spoilage of the nutritional supplement and deliver an appealing product to consumers.

### BRIEF SUMMARY OF THE INVENTION

The present invention discloses a nutritional supplement that aids in naturally treating various human conditions. The nutritional supplement according to the present invention aids in the promotion and acceleration of weight loss when combined with regular exercise, and assists in the treatment of mental conditions such as Alzheimer's Disease, dementia, and the like. Additionally, the nutritional supplement reduces the risks of heart disease.

According to one embodiment of the present invention, a capsule for delivering a nutritional supplement to the human body comprises a fish oil having at least a 30% concentration of at least one omega-3 fatty acid. The capsule also includes at least a 7.5 mg concentration of caffeine. The caffeine is microencapsulated and at least partially suspended in the fish oil. Vitamin E may be further added to prevent spoilage. The capsule delivers a dosage of between 500 mg and 1200 mg.

According to another embodiment of the present invention, a method of delivering a nutritional supplement to the human body comprises encapsulating, in at least one softgel capsule, a composition including a fish oil having at least a 30% concentration of at least one omega-3 fatty acid, at least a 7.5 mg concentration of caffeine microencapsulated and at least partially suspended in the fish oil. Vitamin E may be further added to prevent spoilage. The at least one encapsulated softgel capsule composition delivers a dosage of between 500 mg and 1200 mg.

According to yet another embodiment of the present invention, a method of accelerating weight loss comprises delivering to a human body a fish oil concentration of which at least 30% is at least one omega-3 fatty acid. The method also includes delivering to a human body at least 7.5 mg concentration of caffeine microencapsulated and at least partially suspended within the fish oil concentration. Vitamin E may be further added to prevent spoilage. The fish oil concentration, the at least 7.5 mg concentration of caffeine, and the vitamin E are delivered via an encapsulated softgel composition that delivers a total dosage of between 500 mg and 1200 mg.

Other features and advantages of the present invention will become more apparent from the following description of the embodiments, taken together with the accompanying several views of the drawings, which illustrate, by way of example, the principles of the invention.

### BRIEF DESCRIPTION OF THE SEVERAL VIEWS OF THE DRAWING

Not applicable.

### DETAILED DESCRIPTION OF THE INVENTION

In the following description of the present invention reference is made to the accompanying drawings which form a part thereof, and in which is shown, by way of illustration, exemplary embodiments illustrating the principles of the present invention and how it may be practiced. It is to be understood that other embodiments may be utilized to practice the present invention and structural and functional changes may be made thereto without departing from the scope of the present invention.

In light of the above considerations, there is a need in the art for a nutritional supplement that aids in accelerating weight loss and is derived from natural substances, and is formulated and packaged in such a way that the product has a long shelf life and delivery to humans is safe and appealing. Specific combinations of omega-3 fatty acids and caffeine of the present invention as disclosed herein, when combined with exercise, promote and accelerate weight loss. Additionally, such combinations promote the reduction of plaque on the brain, thereby aiding in the treatment of Alzheimer's, dementia, and other similar mental illnesses. The aforementioned combinations also reduce the risks of heart disease.

Omega-3 fatty acids are considered essential fatty acids. Omega-3 fatty acids are a family of polyunsaturated fatty acids that have well-known properties beneficial to human health. Humans require them, but must obtain them through diet as they lack the enzymes necessary to synthesize polyunsaturated fatty acids. There are many different types of naturally occurring omega-3 fatty acids. Important nutritionally-essential omega-3 fatty acids include eicosapentaenoic acid (EPA), and docosahexaenoic acid (DHA), both of which are polyunsaturated and both of which are known to provide numerous health benefits to humans. Omega-3 fatty acids are naturally found in fish and in fish oils, in particular body oil derived from fish. Suitable species include, but are not limited to, salmon, sardine, anchovy, swordfish, tuna, mackerel, and shark. EPA and DHA, the best omega-3 fatty acids responsible for the health benefits in humans, are derived predominantly from fatty fish. Commercially-available fish oil is comprised of about at least 30% omega-3 fatty acids, and distilled, higher concentrations are also commercially available. Additionally, cod liver oil may be utilized, which has the added benefit of containing naturally-occurring vitamin A and vitamin D. Other oils that may be utilized include oil from crustaceans and other shrimp-like invertebrates such as krill.

Caffeine is a well-known, naturally occurring psychoactive stimulant. Caffeine is found in varying quantities in the beans, leaves, and fruit of some plants, and is most commonly consumed by humans in infusions extracted from the cherries of the coffee plant and the leaves of the tea bush. Caffeine may also be derived from guarana, which is a dietary supplement and an effective energy booster, containing about twice the caffeine found in coffee beans.

In a preferred embodiment of the present invention, a nutritional supplement for accelerating weight loss according to the present invention is capsulated in 1000 mg softgel capsules. The total dosage of the softgel may vary between 500 mg and up to 1200 mg. The nutritional supplement includes a fish oil having between a 60% and a 70% concentration of at least one omega-3 fatty acid, and between 7.5 mg and 65 mg of caffeine. The nutritional supplement is encapsulated in a soft gelatin form according to known methods for ease of delivery to the human body. The nutritional supplement may also include vitamin E to prevent spoilage, or any other spoilage retardation agent commonly known and used with nutritional supplements.

In a capsulated form, the nutritional supplement may be ingested and consumed directly by a person by swallowing the capsule either alone or with another liquid. The nutritional supplement may also be ingested via other known methods, such a hard capsule, and may also be ingested in liquid form, either directly or by dissolving a soluble capsule in a liquid.

In one embodiment, the caffeine is microencapsulated and at least partially suspended within the fish oil to retard spoilage of the fish oil and to improve the appearance and taste of the nutritional supplement. Omega-3 fatty acids are generally unstable, and negatively react with caffeine to form a gritty substance Therefore, it is advantageous to maintain the caffeine and fish oil separate prior to delivery to the human body.

Various concentrations of both omega-3 fatty acids and caffeine are contemplated in different embodiments of the present invention. In one embodiment, the present invention contemplates use of a fish oil in which there is at least 30% concentration of omega-3 fatty acids. In another embodiment, the present invention contemplates use of a fish oil that has between a 30% concentration and a 75% concentration of at least one omega-3 fatty acid.

In the each of the above embodiments, the fish oil includes at least one omega-3 fatty acid. The fish oil may contain eicosapentaenoic acid (EPA), or docosahexaenoic acid (DHA). One embodiment, both EPA and DHA are present in the fish oil.

The present invention also contemplates, in one embodiment, at least a 7.5 mg concentration of caffeine. In another embodiment, the present invention contemplates a concentration of caffeine between 15 mg and 100 mg. In yet another embodiment, the present invention contemplates a concentration of caffeine between 7.5 mg and 65 mg. In still another embodiment, the present invention contemplates a concentration of caffeine between 30 mg and 60 mg.

The present invention also contemplates a method of delivering a nutritional supplement to the human body. Such a method comprises encapsulating, in a softgel capsule, a composition that includes a fish oil as described above. The fish oil according to one embodiment has at least a 30% concentration of at least one omega-3 fatty acid. The composition also includes caffeine, which in one embodiment occurs in at least a 7.5 mg concentration. The caffeine may be microencapsulated and at least partially suspended in the fish oil. The composition may also include vitamin E to prevent spoilage. The encapsulated softgel capsule composition delivers a dosage of between 500 mg and up to 1200 mg to the human body.

The present invention further contemplates a method of accelerating weight loss. The method comprises delivering to a human body a fish oil concentration. The fish oil according to one embodiment has at least a 30% concentration of at least one omega-3 fatty acid. The method also includes delivering to a human body a concentration of caffeine, which according to one embodiment is at least 7.5 mg concentration of caffeine. The caffeine may be microencapsulated and at least partially suspended within the fish oil concentration. The method may also include delivering to a human body vitamin E. The fish oil concentration, the concentration of caffeine, and the vitamin E are delivered via an encapsulated softgel composition that delivers a total dosage of between 500 mg and up to 1200 mg.

A nutritional supplement and methods of delivering a nutritional supplement according to the present invention have a variety of therapeutic applications. As described above, the present invention contemplates that the nutritional supplement disclosed herein may be used to accelerate weight loss when combined with exercise. The nutritional supplement may also be used to promote wellness, alleviate symptoms, and/or treat a variety of other conditions. For example, the nutritional supplement and specific compositions disclosed herein are effective for reducing risks of heart disease and heart attack, and generally aid in promoting cardiovascular health. As discussed above, various mental illnesses and conditions may also be treated such that, at least, symptoms are alleviated. Examples include dementia, Alzheimer's Disease, Parkinson's Disease, and other illnesses of the mind. The nutritional supplement of the present invention may aid in reducing the effects of such illnesses by reducing plaque on the human brain. Even more, the nutritional supplement of the present invention may simply promote wellness as a daily dietary supplement, causing alertness levels to rise, and a general positive mental outlook for those ingesting the nutritional supplement.

It is to be understood that other embodiments may be utilized and structural and functional changes me be made without departing from the scope of the present invention. The foregoing descriptions of the embodiments of the invention have been presented for the purposes of illustration and description. It is not intended to be exhaustive or to limit the invention to the precise forms disclosed. Accordingly, many modifications and variations are possible in light of the above teachings. For example, the nutritional supplement may be delivered via a hard capsule and ingested by swallowing the capsule. Alternatively, the nutritional supplement may be provided in powdered form and ingested by dissolving the powder in a liquid, or may be provided in suppository form and ingested via insertion. It is therefore intended that the scope of the invention not be limited by this detailed description.

1. A capsule for delivering a nutritional supplement to the human body comprising:
a fish oil having at least one omega-3 fatty acid; and
a concentration of caffeine, microencapsulated and at least partially suspended in the fish oil.

2. The capsule of claim 1, further comprising a spoilage retardation agent.

3. The capsule of claim 2, wherein the spoilage retardation agent is vitamin E.

4. The capsule of claim 1, wherein the fish oil has at least a 30% concentration of the at least one omega-3 fatty acid.

5. The capsule of claim 1, wherein the concentration of caffeine is at least 7.5 mg.

6. The capsule of claim 1, wherein the capsule delivers a dosage of between 500 mg and 1200 mg.

7. The capsule of claim 1, wherein the nutritional supplement accelerates weight loss.

8. The capsule of claim 1, wherein the fish oil is derived from fish body oil.

9. The capsule of claim 1, wherein the fish oil is derived from cod liver oil.

10. The capsule of claim 1, wherein the fish oil is derived from krill oil.

11. The capsule of claim 1, wherein the nutritional supplement is a composition in gel form.

12. The capsule of claim 1, wherein the at least one omega-3 fatty acid is EPA.

13. The capsule of claim 1, wherein the at least one omega-3 fatty acid is DHA.

14. The capsule of claim 1, wherein the at least one omega-3 fatty acid is EPA and DHA.

15. The capsule of claim 1, wherein the caffeine is microencapsulated and at least partially suspended in the fish oil to prevent spoilage of the fish oil.

16. The capsule of claim 1, wherein the caffeine is derived from guarana extract.

17. The capsule of claim 5, wherein the at least 7.5 mg concentration of caffeine is a concentration of between 15 mg and 100 mg.

18. The capsule of claim 5, wherein the at least 7.5 mg concentration of caffeine is a concentration of between 30 mg and 60 mg.

19. The capsule of claim 5, wherein the at least 7.5 mg concentration of caffeine is a concentration of between 35 mg and 65 mg.

20. The capsule of claim 5, wherein the at least 7.5 mg concentration of caffeine is a concentration of between 7.5 mg and 65 mg.

21. The capsule of claim 1, wherein the fish oil has between a 30% concentration and a 75% concentration of at least one omega-3 fatty acid.

22. The capsule of claim 1, wherein the fish oil has between a 60% concentration and a 70% concentration of at least one omega-3 fatty acid.

23. A method of delivering a nutritional supplement to the human body, comprising encapsulating, in at least one softgel capsule, a composition including a fish oil having at least one omega-3 fatty acid, and a concentration of caffeine microencapsulated and at least partially suspended in the fish oil.

24. The method of claim 23, further comprising encapsulating vitamin E in the softgel capsule.

25. The method of claim 23, wherein the fish oil has at least a 30% concentration of the at least one omega-3 fatty acid.

26. The method of claim 25, wherein the fish oil has between a 30% concentration and a 75% concentration of the at least one omega-3 fatty acid.

27. The method of claim 25, wherein the fish oil has between a 60% concentration and a 70% concentration of the at least one omega-3 fatty acid.

28. The method of claim 23, wherein the fish oil is derived from fish body oil.

29. The method of claim 23, wherein the fish oil is derived from cod liver oil.

30. The method of claim 23, wherein the fish oil is derived from krill oil.

31. The method of claim 23, further comprising at least a 7.5 mg concentration of the caffeine.

32. The method of claim 23, wherein the at least one encapsulated softgel capsule composition delivers a dosage of between 500 mg and 1200 mg.

33. The method of claim 23, wherein the at least one omega-3 fatty acid is EPA.

34. The method of claim 23, wherein the at least one omega-3 fatty acid is DHA.

35. The method of claim 23, wherein the at least one omega-3 fatty acid is EPA and DHA.

36. The method of claim 23, wherein the caffeine is microencapsulated and at least partially suspended in the fish oil to prevent spoilage of the fish oil.

37. The method of claim 23, further comprising deriving the caffeine from guarana extract.

38. A method of accelerating weight loss, comprising:
delivering to a human body a fish oil having at least one omega-3 fatty acid; and
delivering to a human body a concentration of caffeine microencapsulated and at least partially suspended within the fish oil concentration,
wherein the fish oil and the concentration of caffeine are delivered via an encapsulated softgel composition.

39. The method of claim 38, wherein the fish oil has at least a 30% concentration of the at least one omega-3 fatty acid.

40. The method of claim 38, further comprising at least a 7.5 mg concentration of the caffeine.

41. The method of claim 38, further comprising delivering to the human body a total dosage of between 500 mg and 1200 mg.

42. The method of claim 38, further comprising delivering to the human body vitamin E to act as a spoilage retardation agent for the encapsulated softgel composition.

43. The method of claim 38, further comprising deriving the fish oil from fish body oil.

44. The method of claim 38, further comprising deriving the fish oil from cod liver oil.

45. The method of claim 38, further comprising deriving the fish oil from krill oil.

46. The method of claim 38, wherein the delivering to a human body a fish oil concentration of which at least 30% is at least one omega-3 fatty acid further comprises delivering EPA.

47. The method of claim 38, wherein the delivering to a human body a fish oil concentration of which at least 30% is at least one omega-3 fatty acid further comprises delivering DHA.

48. The method of claim 38, wherein the delivering to a human body a fish oil concentration of which at least 30% is at least one omega-3 fatty acid further comprises delivering EPA and DHA.

49. The method of claim 38, wherein the delivering to a human body a concentration of caffeine further comprises deriving the caffeine from guarana extract.

50. The method of claim 40, wherein the delivering to a human body at least a 7.5 mg concentration of caffeine further comprises delivering a concentration of between 15 mg and 100 mg.

51. The method of claim 40, wherein the delivering to a human body at least a 7.5 mg concentration of caffeine further comprises delivering a concentration of between 30 mg and 60 mg.

52. The method of claim 40, wherein the delivering to a human body at least 15 mg concentration of caffeine further comprises delivering a concentration of between 35 mg and 65 mg.

53. The method of claim 40, wherein the delivering to a human body at least a 7.5 mg concentration of caffeine further comprises delivering a concentration of between 7.5 mg and 65 mg.

54. The method of claim 39, wherein delivering to a human body a fish oil concentration further comprises delivering a fish oil concentration that has between a 30% concentration and a 75% concentration of at least one omega-3 fatty acid.

55. The method of claim 39, wherein delivering to a human body a fish oil concentration further comprises delivering a fish oil concentration that has between a 60% concentration and a 70% concentration of at least one omega-3 fatty acid.
